(19) United States
(12) Patent Application Publication
(10) Pub. No.: US 2019/0208069 A1
(43) Pub. Date: Jul. 4, 2019

(54) APPARATUS WITH LIGHT SOURCES

(71) Applicant: Hewlett-Packard Development Company, L.P., Spring, TX (US)

(72) Inventors: Peter G Hwang, Vancouver, WA (US); Steve O Rasmussen, Vancouver, WA (US); Stephen G Brown, Vancouver, WA (US); Bruce G Johnson, Vancouver, WA (US); Ki Jung Han, Vancouver, WA (US)

(21) Appl. No.: 16/332,085

(22) PCT Filed: Sep. 12, 2016
(86) PCT No.: PCT/US2016/051344

§ 371 Date: Mar. 11, 2019

(51) Int. Cl. H04N 1/00; B41J 13/10

(52) U.S. Cl. CPC H04N 1/00697; B41J 13/106; H04N 1/00771; H04N 1/00633

(57) ABSTRACT

According to an example, a printing apparatus may include a first output bin, a second output bin, a first light source positioned to illuminate a portion of the first output bin, a second light source positioned to illuminate a portion of the second output bin, and a controller. The controller may activate the first light source in response to a media being outputted to the first output bin and may activate the second light source in response to a media being outputted to the second output bin to direct a user to the first output bin and/or the second output bin containing a most recently printed media.

### CROSS REFERENCE TO RELATED APPLICATION

The present application contains similar information to PCT/US2015/064674 filed on Dec. 9, 2015, the disclosure of which is hereby incorporated by reference in its entirety.

### BACKGROUND

Many printing systems have multiple media output collection areas where printed media is outputted. The media output collection areas are often positioned beneath sections of the printing systems and/or in a stacked relation to each other.

### BRIEF DESCRIPTION OF THE DRAWINGS

Features of the present disclosure are illustrated by way of example and not limited in the following figure(s), in which like numerals indicate like elements, in which:

FIG. 1 depicts a block diagram of an example printing apparatuses;

FIGS. 2A and 2B, respectively, depict diagrams of example printing apparatuses;

FIGS. 3-6 respectively depict block diagrams of other example printing apparatuses.

### DETAILED DESCRIPTION

Disclosed herein are printing apparatuses that may include multiple output bins to which printed media may be outputted. The printing apparatuses may also include multiple light sources that are to become activated to illuminate the output bins during and/or after printed media is outputted to the output bins. For instance, a first light source may be positioned to illuminate a first output bin and a second light source may be positioned to illuminate a second output bin. In some examples, the first light source may be activated in response to a media being outputted to the first output bin and the second light source may be activated in response to a media being outputted to the second output bin. The output bins may be illuminated, for instance, to direct a user's attention to the bin to which printed media has been outputted.

In addition, the light sources may be positioned such that media passes through the light from the light sources as the media is being outputted to the output bins. As a plurality of the media passes through the light, the media may cause a pulsating effect on the light, in which the pulsating effect may vary depending upon the speed at which the media is outputted onto the output bins.

Also disclosed herein are printing apparatuses that may include a mezzanine containing a media finisher. The mezzanine may also include a light source that is to shine a light through an open area in the mezzanine. As media is conveyed past the light source, the media may intermittently block the light shining through the open area to create a pulsating shadow effect of the light. In one regard, the pulsating shadow effect may provide a user with a visualization of the media movement through the mezzanine. As used herein, the terms “a” and “an” are intended to denote at least one of a particular element, the term “includes” means includes but not limited to, the term “including” means including but not limited to, and the term “based on” means based at least in part on.

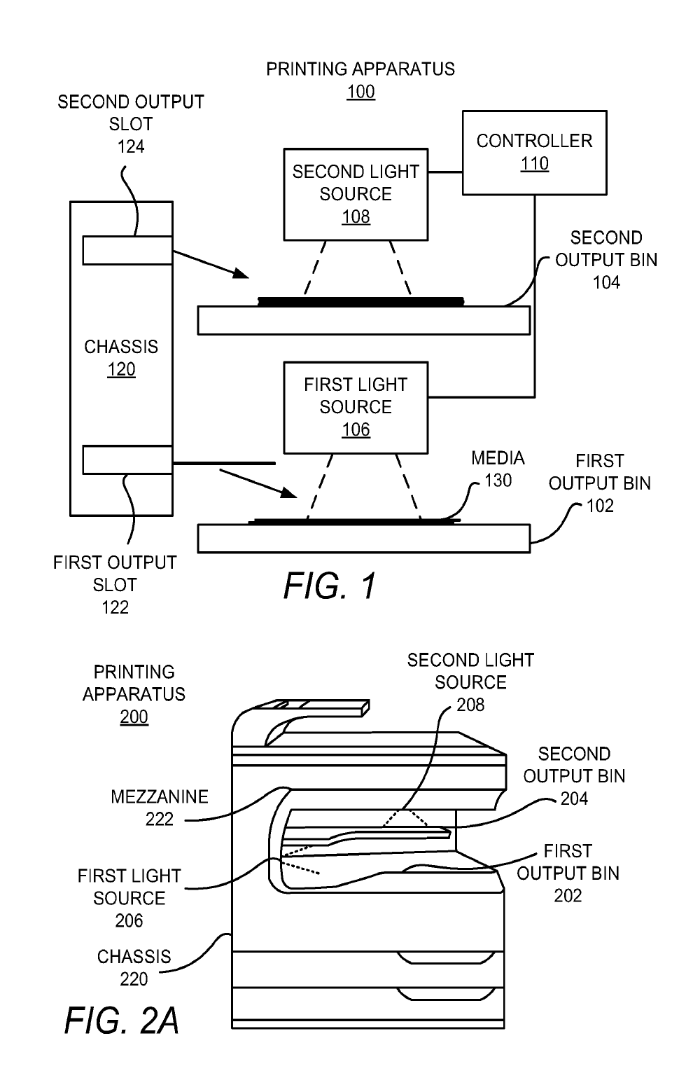

With reference first to FIG. 1, there is shown a block diagram of an example printing apparatus 100. Generally speaking, the printing apparatus 100 may be a printer, a multi-function printer, or the like. It should be understood that the printing apparatus 100 depicted in FIG. 1 may include additional components and that some of the components described herein may be removed and/or modified without departing from a scope of the printing apparatus 100 disclosed herein. For instance, although particular reference is made herein to the printing apparatuses including two output bins, it should be understood that printing apparatuses including any number of output bins may be implemented in manners disclosed herein.

Although not shown, the printing apparatus 100 may include printing components that may represent any mechanical, electrical, or electromechanical part of the printing apparatus 100. The printing apparatus 100 may be an inkjet printing system, a laser printing system, or the like. An example inkjet printing system may include components such as a fluid ejection assembly (e.g., a printhead assembly), a fluid supply assembly, a carriage assembly, a print media transport assembly, a service station assembly, and an electronic controller to facilitate control of the any number of components. The printing components may also include a print bar, a paper guide, a separator pad, a pinch roller, an alignment roller, a starwheel, a drum, a clamp, a servo, a pick tire, a fan, a tray, a bail, a power control unit, alignment devices, a stapler device, a hole punch device, a saddle stitching device, and the like. Example laser (e.g. toner) printing systems and may contain similar components, related components, or different components, such as toner cartridges, toner drums, etc.

The printing apparatus 100 may have a first output bin 102 and a second output bin 104. The first output bin 102 may equivalently be termed a first output tray and the second output bin 104 may equivalently be termed a second output tray. The printing apparatus 100 may also include a first light source 106 and a second light source 108, which may both be light emitting diodes (LEDs), lasers, incandescent light bulbs, or the like. The first light source 106 may illuminate a portion of the first output bin 102 as indicated by the dashed lines emanating from the first light source 106. Likewise, the second light source 106 may illuminate a portion of the second output bin 104 as indicated by the dashed lines emanating from the second light source 108.

The printing apparatus 100 may further include a controller 110 and a chassis 120. The chassis 120 may include a first output slot 122 and a second output slot 124 through which media 130 may be expelled. The chassis 120 may represent a frame and outer covering of the printing apparatus 100 within which the components of the printing apparatus 100, including the controller 110, may be housed. In various examples, however, the first output bin 102 and the second output bin 104 may be positioned externally to the chassis 120. In any regard, the first output slot 122 and the second output slot 124 may include various elements for expelling media 130 from the chassis 120 and into the first output bin 102 and the second output bin 104, such as rollers, guides, etc.

The controller 110 may be a semiconductor-based microprocessor, a central processing unit (CPU), an application specific integrated circuit (ASIC), or other hardware device that may control various components in the printing apparatus 100. For instance, and as shown in FIG. 1, the controller 110 may control the first light source 106 and the second light source 108. In various examples, the controller 110 may determine that media 130 upon which marking material has been applied is about to be, is in the process of being, or has been outputted through the first output slot 122 and/or the second output slot 124. The controller 110 may make this determination based upon receipt of information from printing components and/or sensor(s) positioned to detect movement of media into, through, and/or out of the first output slot 122 and the second output slot 124.

In addition, the controller 110 may activate the first light source 106 in response to a determination that media 130 is being outputted to the first output bin 102, may activate the second light source 108 in response to a determination media is being outputted to the second output bin 104, or both. In one regard, the controller 110 may activate the first light source 106 and/or the second light source 108 to identify into which of the output bins 102, 104 a most recently printed media 130 is or has been expelled. As such, for instance, a user may be directed to the first output bin 102 and/or the second output bin 104 as containing a most recently printed media 130.

According to an example, the controller 110 may maintain the first light source 106 and/or the second light source 108 in an activated state, i.e., in a state that illuminates the first output bin 102 and/or the second output bin 104 for a predetermined length of time following activation of either or both of the first light source 106 and the second light source 108. In an example, the predetermined length of time may be selected as a length of time that is sufficient for a user who submitted a print job from a remote client device to reach the printing apparatus 200 and view the light from the first light source 106 and/or the second light source 108. In other examples, the predetermined length of time may be user-definable or may be set by the printing apparatus 200 manufacturer. By way of particular example, the predetermined length of time may be set to be about 3 minutes to about 10 minutes.

According to an example, the first light source 106 and/or the second light source 108 may be activated during expulsion of the media 130 through the first output slot 122 and/or the second output slot 124. In various examples, the media 130 may be expelled at relatively high speeds, e.g., about 80 pages per minute. As the media 130 passes through the illumination created by the first light source 106 and/or the second light source 108, the media 130 may cause the illumination to pulsate. The pulsating effect on the illumination may enable an observer to visualize the speed at which the media 130 is being expelled.

Examples of the media may include any type of suitable sheet material, such as paper, card stock, transparencies, fabric, packaging material, and the like. Examples of the marking material may include ink, toner, or other type of marking material having one or multiple colors.

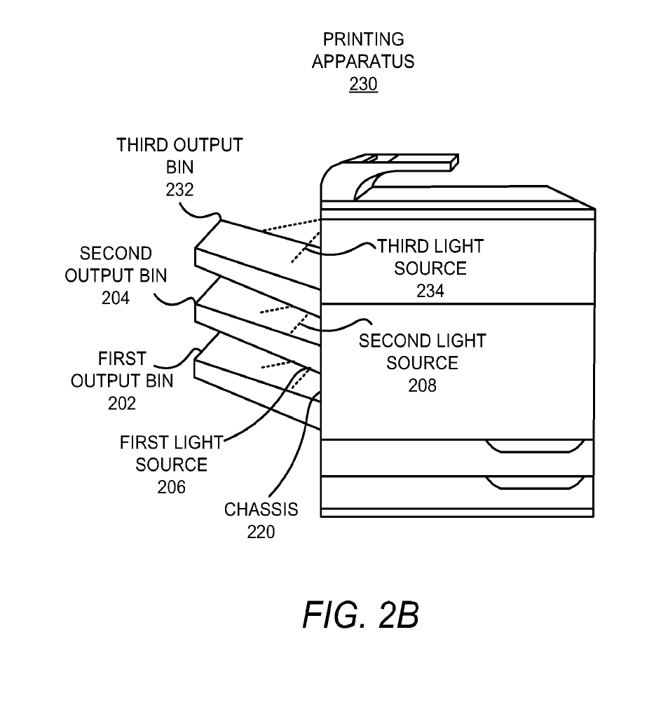

With reference now to FIGS. 2A and 2B, there are respectively shown diagrams of example printing apparatuses 200 and 230. The printing apparatuses 200, 230 may each be a multi-function device, laser printer, or the like. As shown, the printing apparatuses 200, 230 may include a first output bin 202, a second output bin 204, a first light source 206, and a second light source 208. The printing apparatuses 200, 230 may also include a chassis 220 that houses a controller (not shown) and includes a first output slot (not shown) and a second output slot (not shown) through which media may be expelled onto the first output bin 202 and the second output bin 204, respectively. The chassis 220 shown in FIG. 2A may also include a mezzanine 222 that may include a media finisher (not shown) that may perform various finishing operations on media. The finishing operations may include, for instance, stapling, straightening, tightening, or the like, on a stack of media prior to being expelled onto the second output bin 204.

As shown in FIGS. 2A and 2B, the first light source 206 may be positioned on a vertically extending wall of the chassis 220. For instance, the first light source 206 may be positioned adjacent to, e.g., above or below, a first output slot positioned on the vertically extending wall. In addition, the second light source 208 may be positioned on a horizontally extending wall of the chassis 220 located on a bottom of the mezzanine 222. Although not shown, the second output slot may be provided on the horizontally extending wall such that media may be dropped from the mezzanine 222 onto the second output bin 204 (or equivalently, second output tray) following performance of a finishing operation on the media. The second light source 208 may be positioned on the horizontally extending wall and adjacent to the second output slot. In any regard, the first light source 206 may be equivalent to the first light source 106 depicted in FIG. 1 and the second light source 208 may be equivalent to the second light source 108 depicted in FIG. 1.

The printing apparatus 230 shown in FIG. 2B may also include a third output bin 232 and a third light source 234. The third light source 234 may be similar to the either or both of the first light source 206 and the second light source 208 and the controller 110 may control the third light source 234 in similar manners to those discussed above with respect to the first light source 206 and the second light source 208. The third light source 234 may also be positioned on a wall adjacent to a third output slot (not shown) or on a roof of the third output slot. Additionally, the output bins 202, 204, 232 may extend out from a side of the printing apparatus 230. In other examples, one or more of the output bins 202, 204, 232 and light sources 206, 208, 234 may be positioned on top of the chassis 220 such that media may be outputted to those output bins 202, 204, 232 and that the light sources 206, 208, 234 may illuminate media in those output bins 202, 204, 232.

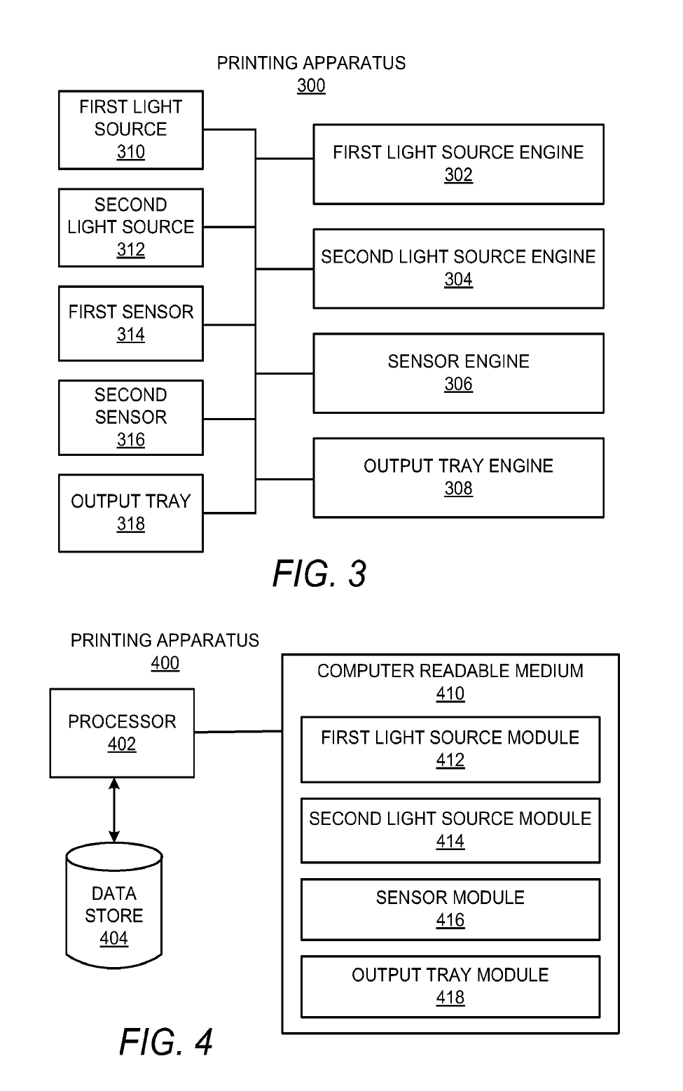

Turning now to FIG. 3, there is shown a block diagram depicting an example printing apparatus 300. It should be understood that the printing apparatus 300 depicted in FIG. 3 may include additional components and that some of the components described herein may be removed and/or modified without departing from a scope of the printing apparatus 300 disclosed herein.

The printing apparatus 300 may include a first light source engine 302, a second light source engine 304, a sensor engine 306, and an output tray engine 308. The printing apparatus 300 may also include a first light source 310, a second light source 312, a first sensor 314, a second sensor 316, and an output tray 318. The first light source 310 and the second light source 312 may respectively be equivalent to the first light source 106, 206, and the second light source 108, 208 depicted in FIGS. 1 and 2. In some examples, the first sensor 314 may be positioned within a chassis of the printing apparatus 300 to detect movement of media into, through, and/or out of a first output slot of the chassis. The second sensor 316 may be positioned within the chassis of the printing apparatus 300 to detect movement of media into, through, and/or out of a first output slot of the chassis. In some examples, the first sensor 314 may detect the presence and removal of media from the first output bin 102, 202. Likewise, the second sensor 316 may detect the presence and removal of media from the second output bin 104, 204. The first sensor 314 and the second sensor 316 may be optical sensors, mechanical sensors, or the like.

The first light source engine 302 may represent any circuitry or combination of circuitry and executable instructions to control the first light source 310. For instance, the first light source engine 302 may determine that media upon which marking material has been applied is about to be, is in the process of being, or has been outputted through the first output slot. The first light source engine 302 may make this determination based upon receipt of information from printing components and/or the sensor engine 306. For instance, the first light source engine 302 may automatically activate the first light source 310 when a motor to drive the media out of the first output slot 122 is activated.

The second light source engine 304 may represent any circuitry or combination of circuitry and executable instructions to control the second light source 312. For instance, the second light source engine 304 may determine that media upon which marking material has been applied is about to be, is in the process of being, or has been outputted through the second output slot. The second light source engine 304 may make this determination based upon receipt of information from printing components and/or the sensor engine 306. For instance, the second light source engine 304 may automatically activate the second light source 312 when a motor to drive the media out of the second output slot 124 is activated.

The sensor engine 306 may represent any circuitry or combination of circuitry and executable instructions to receive signals from the first sensor 314 and the second sensor 316 and to communicate the received signals to the first light source engine 302 and/or the second light source engine 304. The sensor engine 306 may receive signals from the first sensor 314 when the first sensor 314 detects that media is moving into, through, or out of the first output slot. The sensor engine 306 may also receive signals from the second sensor 316 when the second sensor 316 detects that media is moving into, through or out of the second output slot. In response to receipt of the signals, the sensor engine 306 may communicate a signal to either or both of the first light source engine 302 and the second light source engine 304. The first sensor 314 and the sensor 316 may be optional because, as noted above, the first light source 310 and the second light source 312 may be activated concurrently with a motor that drives media out of the respective output slots 122, 124.

The first light source engine 302 may control the first light source 310 to become activated in response to receipt of the signal from the sensor engine 306. In addition, the first light source engine 302 may cause the first light source 310 to remain active for a predetermined period of time. The second light source engine 304 may control the second light source engine 312 to become activated in response to receipt of the signal from the sensor engine 306. In addition, the second light source engine 304 may cause the second light source 312 to remain active for a predetermined period of time to illuminate a second output bin. In some examples in which the first sensor 314 and the second sensor 316 are to detect the presence or removal of media from a respective output bin 102, 202, 104, 204, the first light source engine 302 and the second light source engine 304 may respectively deactivate the first light source 310 and the second light source 312 in response to a detection by a sensor 314, 316 of the media removal. In these examples, the first light source 310 and/or the second light source 312 may not remain active for the entire duration of the predetermined period of time.

The output tray engine 308 may represent any circuitry or combination of circuitry and executable instructions to control movement of the output tray 318. The output tray 318 may be a floor of the second output bin 104, 204 depicted in FIGS. 1 and 2 and may be movable between a first position and a second position. In the first position, the output tray 318 may be positioned to enable easier access to media in the first output bin 202, and in the second position, the output tray 318 may enable easier access to media in the second output bin 204. The output tray 318 may be moved in various manners as discussed in PCT/US2015/064674. In some examples, the second light source engine 304 may activate the second light source 312 following movement of the output tray 318 to the second position.

With reference now to FIG. 4, there is shown a block diagram of another example printing apparatus 400. The printing apparatus 400 may include a processor 402 and a computer readable medium 410, in which the computer readable medium 410 is operatively coupled to the processor 402. The computer readable medium 410 may contain a set of instructions that are executable by the processor 402. The printing apparatus 400 may also include a data store 404 on which the processor 402 may store various information, such as print data, etc. The set of instructions may cause the processor 402 to perform operations of the printing apparatus 400 when the processor 402 executes the set of instructions. The set of instructions stored on the computer readable medium 410 may be represented as a first light source module 412, a second light source module 414, a sensor module 416, and an output tray module 418. The first light source module 412, the second light source module 414, the sensor module 416, and the output tray module 418 may represent machine readable instructions that when executed function as the first light source engine 302, the second light source engine 304, the sensor engine 306, and the output tray engine 308 of the printing apparatus 300 depicted in FIG. 3, respectively.

The processor 402 may carry out a set of instructions to execute the modules 412-418, and/or any other appropriate operations among and/or associated with the modules of the printing apparatus 400. For example, the processor 402 may carry out a set of instructions to activate either or both of a first light source and a second light source.

Although modules 412-418 are illustrated and discussed in relation to FIG. 4 and other example implementations, other combinations or sub-combinations of modules may be included within other implementations. Stated differently, although the modules illustrated in FIG. 4 and discussed in other example implementations may perform specific functionalities in the examples discussed herein, these and other functionalities may be accomplished, implemented, or realized at different modules or at combinations of modules. For example, two or more modules illustrated and/or discussed as separate may be combined into a module that performs the functionalities discussed in relation to the two modules. As another example, functionalities performed at one module as discussed in relation to these examples may be performed at a different module or different modules.

The processor 402 may be any appropriate circuitry that is to process (e.g., computing) instructions, such as one or multiple processing elements that may retrieve instructions from the computer readable medium 410 and executing those instructions. For example, the processor 402 may be a central processing unit (CPU) that enables operational adjustment by fetching, decoding, and executing the modules 412-418. Example processors 402 may include at least one CPU, a semiconductor-based microprocessor, a programmable logic device (PLD), and the like. Example PLDs may include an application specific integrated circuit (ASIC), a field-programmable gate array (FPGA), a programmable array logic (PAL), a complex programmable logic device (CPLD), and an erasable programmable logic device (EPLD). The processor 402 may include multiple processing elements that are integrated in a single device or distributed across devices. The processor 402 may process the instructions serially, concurrently, or in partial concurrence.

The computer readable medium 410 may represent a medium to store data utilized and/or produced by the printing apparatus 400. The computer readable medium 410 may be any non-transitory medium or combination of non-transitory mediums able to electronically store data, such as the modules 412-418 and/or data used by the printing apparatus 400. For example, the computer readable medium may be distinct from a transitory transmission medium, such as a signal. As used herein, a non-transitory computer readable medium may refer to any storage medium with the exclusion of a signal. The computer readable medium may be an electronic, magnetic, optical, or other physical storage device that may contain (i.e., store) executable instructions. The computer readable medium 410 may store program instructions that when executed by the processor 402 cause the processor 402 to implement functionality of the printing apparatus 400. The computer readable medium 410 may be integrated in the same device as the processor 402 or may be separate but accessible to that device and the processor 402. The computer readable medium 410 may also be distributed across devices.

In the discussions above, the engines 302-308 shown in FIG. 3 and the modules 412-418 shown in FIG. 4 have been described as circuitry or a combination of circuitry and executable instructions. Such components may be implemented in a number of fashions. With reference to FIG. 4, the executable instructions may be processor-executable instructions, such as program instructions, stored on the computer readable medium 410, which is a tangible, non-transitory computer-readable storage medium, and the circuitry may be electronic circuitry, such as processor 402, for executing those instructions. The instructions residing on the computer readable medium 410 may include any set of instructions to be executed directly (such as machine code) or indirectly (such as a script) by the processor 402.

In some examples, the printing apparatus 400 may include the executable instructions or may be part of an installation package that when installed may be executed by the processor 402 to perform operations of the printing apparatus 400. In that example, the computer readable medium 410 may be a portable medium such as a compact disc, a digital video disc, a flash drive, or memory maintained by a computer device, such as a server, from which the installation package may be downloaded and installed. In another example, the executable instructions may be part of an application or applications already installed. The computer readable medium 410 may be a non-volatile memory resource such as read only memory (ROM), a volatile memory resource such as random access memory (RAM), a storage device, or a combination thereof. Example forms of a computer readable medium 410 may include static RAM (SRAM), dynamic RAM (DRAM), electrically erasable programmable ROM (EEPROM), flash memory, or the like. The computer readable medium 410 may include integrated memory such as a hard drive (HD), a solid state drive (SSD), an optical drive, or the like.

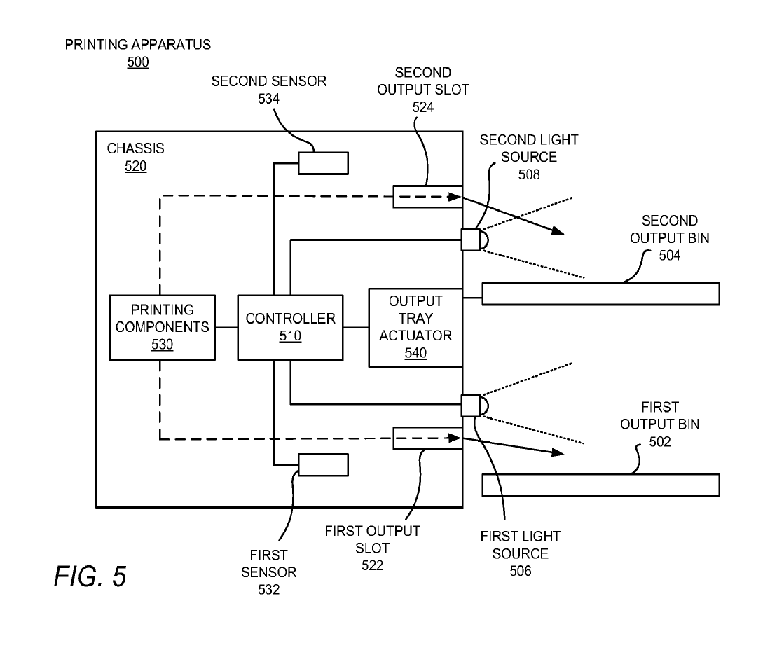

Turning now to FIG. 5, there is shown a block diagram of another example printing apparatus 500. It should be understood that the printing apparatus 500 depicted in FIG. 5 may include additional components and that some of the components described herein may be removed and/or modified without departing from a scope of the printing apparatus 500 disclosed herein. The printing apparatus 500 may be an inkjet printing system, a laser printing system, or the like.

The printing apparatus 500 may include a first output bin 502, a second output bin 504, a first light source 506, a second light source 508, a controller 510, a chassis 520, a first output slot 522, and a second output slot 524. The first output bin 502, the second output bin 504, the first light source 506, the second light source 508, the controller 510, the chassis 520, the first output slot 522, and the second output slot 524 may respectively be equivalent to the first output bin 102, 202, the second output bin 104, 204, the first light source 106, 206, 310, the second light source 108, 208, 312, the controller 110, the chassis 120, 220, the first output slot 122, and the second output slot 124 depicted in FIGS. 1-3. Accordingly, detailed descriptions of these components are not described with respect to FIG. 5. Instead, the descriptions of these components with respect to FIGS. 1-3 may also relate to the components in FIG. 5.

The printing apparatus 500 may also include printing components 530, a first sensor 532, a second sensor 534, and an output tray actuator 540. The first sensor 532 and the second sensor 534 may be an optical sensor, a mechanical sensor, or a combination thereof. The printing components 530 may represent any mechanical, electrical, or electromechanical part of the printing apparatus 500. For instance, the printing components 530 may represent components that are to apply marking material onto media and to convey the media to the first output slot 522 and/or the second output slot 524. The controller 510 may control the printing components 530 such that desired images are applied onto media and the media is conveyed to one of the first output slot 522 and the second output slot 524. Although not shown, the controller 510 may access instructions stored on a computer readable medium to control the printing components 530.

According to an example, as media is fed to the first output slot 522 as indicated by the dashed line from the printing components 530 to the first output slot 522, the media may go past the first sensor 532. As the media passes the first sensor 532, the first sensor 532 may detect the passage of the media. The controller 510 may determine that the media is being directed to the first output slot 522 based upon the detection made by the first sensor 532. Similarly, as the media passes the second sensor 534, the second sensor 534 may detect the passage of the media. The controller 510 may determine that the media is being directed to the second output slot 524 based upon the detection made by the second sensor 534. As discussed above with respect to FIG. 3, however, the first sensor 532 and the second sensor 534 may be omitted and/or the sensors 532, 534 may instead detect the presence and removal of media from the output bins 102, 202, 104, 204.

Additionally, based upon whether the media is detected as being directed to the first output slot 522 or the second output slot 524, the controller 510 may activate one of the first light source 506 and the second light source 508. The controller 510 may also activate the first light source 506 for the second light source 508 for a predetermined period of time as discussed above. In instances in which media is outputted through the second output slot 524 within the predetermined period of time after the first light source 506 has been activated, both of the first light source 506 and the second light source 508 may be activated concurrently. As additional examples, the first light source 506 and/or the second light source 508 may be deactivated prior to expiration of the predetermined period of time, for instance, in response to detection by the first sensor 532 and/or the second sensor 534 of the removal of media from a respective output bin 502, 504.

As shown in FIG. 5, the first light source 506 and the second light source 508 may be positioned on the wall of the chassis 520 adjacent to the first output slot 522 and the second output slot 524, respectively. Although the first light source 506 has been depicted as being positioned above the first output slot 522 and the second light source 508 has been depicted as being positioned below the second output slot 524, it should be understood that both of the light sources 506, 508 may respectively be positioned above the output slots 522, 524 or below the output slots 522, 524. As additional examples, the first light source 506 and/or the second light source 508 may be positioned on a roof of the first output slot 522 and a roof of the second output slot 524, respectively.

As discussed above with respect to FIG. 3, the second output bin 504, or equivalently, the second output tray, may be movable between a first position and a second position. In some examples, the controller 510 may control the output tray actuator 540 to move the second output bin 504 between the first position and the second position. The output tray actuator 540 may include similar components to those discussed in PCT/US2015/064674.

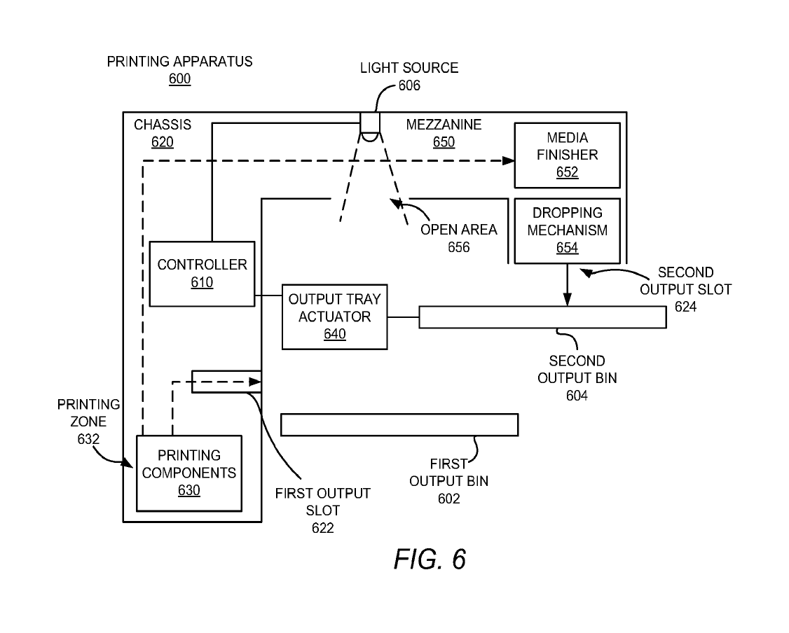

With reference now to FIG. 6, there is shown a block diagram of another example printing apparatus 600. It should be understood that the printing apparatus 600 depicted in FIG. 6 may include additional components and that some of the components described herein may be removed and/or modified without departing from a scope of the printing apparatus 600 disclosed herein. The printing apparatus 600 may be an inkjet printing system, a laser printing system, or the like.

The printing apparatus 600 may include a first output bin 602, a second output bin 604, a light source 606, a controller 610, a chassis 620, a first output slot 622, and a second output slot 624. The first output bin 602, the second output bin 604, the controller 610, the chassis 620, the first output slot 622, and the second output slot 624 may respectively be equivalent to the first output bin 102, 202, the second output bin 104, 204, the controller 110, the chassis 120, 220, the first output slot 122, and the second output slot 124 depicted in FIGS. 1-3. The light source 606 may be equivalent to the first light source 106, 206. Accordingly, detailed descriptions of these components are not described with respect to FIG. 6. Instead, the descriptions of these components with respect to FIGS. 1-3 may also relate to the components in FIG. 6.

In contrast to the printing apparatuses depicted in FIGS. 1-5, however, details of various features in the mezzanine 650 of the printing apparatus 620 are shown in FIG. 6. That is, the mezzanine 650, which may be equivalent to the mezzanine 222 depicted in FIG. 2A, may include a media finisher 652 and a dropping mechanism 654. In operation, media that receives marking material in a printing zone 632 by the printing components 630 may be conveyed to the media finisher 652 located in the mezzanine 650 as denoted by the dashed line from the printing components 630 to the media finisher 652. As shown, the mezzanine 650 may include an open area 656 through which light from the light source 606 may be directed. As media is conveyed through the mezzanine 650, the media may pass through the light emitted by the light source 606 thus causing the light to be broken up by the media. In one regard, the light from the light source 606, which may shine upon the second output bin 604, may be intermittently visible as the media passes by the light source 606, e.g., as a pulsating shadow effect. The pulsating shadow effect of the light may provide an indication to a viewer that media is moving through the mezzanine 650 and the rate at which the media is moving. Although not shown, another light source may be provided to illuminate the first output bin 602.

The controller 610 may determine when media is conveyed or is to be conveyed to the media finisher 652 and may activate the light source 606 in response to making this determination. In addition, the controller 610 may keep the light source 606 activated during the entire time at which media is conveyed from the printing zone 632 to the media finisher 652. Once a plurality of media reaches the media finisher 652, the media finisher 652 may stack, staple, straighten, tighten, etc., the plurality of media. In addition, the dropping mechanism may drop the plurality of media onto the second output bin 604 through the second output slot 624.

According to an example, the second output bin 604 may be movable as discussed above. In this example, the controller 610 may control the output tray actuator 640, which may be equivalent to the output tray actuator 540 depicted in FIG. 5, to position the second output bin 604 beneath the second output slot when the controller 610 determines that the dropping mechanism 654 is to drop the plurality of media.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A printing apparatus comprising:
a first output bin;
a second output bin;
a first light source positioned to illuminate a portion of the first output bin;
a second light source positioned to illuminate a portion of the second output bin; and
a controller to activate the first light source in response to a media being outputted to the first output bin and to activate the second light source in response to a media being outputted to the second output bin to direct a user to the first output bin and/or the second output bin containing a most recently printed media.

2. The printing apparatus according to claim 1, wherein the controller is to maintain either or both of the first light source and the second light source in an activated state for a predetermined length of time following activation of either or both of the first light source and the second light source.

3. The printing apparatus according to claim 1, further comprising a first sensor to detect when media has been removed from the first output bin, wherein the controller is to deactivate the first light source in response to a detection by the first sensor that media has been removed from the first output bin.

4. The printing apparatus according to claim 1, further comprising:
a first output slot formed in a wall, wherein the media is to be outputted to the first output bin through the first output slot, and wherein the first light source is positioned on one of the wall adjacent to the first output slot and a roof of the first output slot.

5. The printing apparatus according to claim 4, further comprising:
a first sensor to detect media being outputted through the first output slot, wherein the controller is to activate the first light source in response to receipt of signal from the first sensor that media is being outputted through the first output slot.

6. The printing apparatus according to claim 4, wherein the first light source is positioned to cause media outputted through the first output slot to be pulsed as the media is outputted from the first output slot and onto the first output bin.

7. The printing apparatus according to claim 1, further comprising:
a second output slot, wherein the media is to be outputted to the second output bin through the second output slot, and wherein the second light source is positioned on one of the wall adjacent to the second output slot and a roof of the second output slot.

8. The printing apparatus according to claim 7, wherein the second light source is positioned to cause media outputted through the second output slot to be pulsed as the media is outputted from the second output slot and onto the second output bin.

9. The printing apparatus according to claim 1, wherein the second output bin includes an output tray, wherein the controller is to translate the output tray following deposition of media on the output tray, and wherein the controller is to activate the second light source following translation of the output tray.

10. A printing apparatus comprising:
a printing zone;
an output tray;
a mezzanine located above the output bin;
a media finisher housed in the mezzanine, wherein media is transported from the printing zone, through an open area in the mezzanine, and to the media finisher;
a light source to direct light through the open area, wherein the media is to pass through the light as the media is transported through the open area to the media finishing area to display a pulsating shadow effect of the light on the output bin.

11. The printing apparatus according to claim 10, further comprising:
a dropping mechanism to drop media from the mezzanine and onto the output tray following performance of a finishing operation by the media finisher on the media.

12. An apparatus comprising:
a first light source engine to activate a first light source in response to a media being outputted to a first output bin of a printer; and
a second light source engine to activate a second light source in response to a media being outputted to a second output bin of the printer to direct attention to either or both of the first output bin and the second output bin containing a recently printed media.

13. The apparatus according to claim 12, wherein the first light source engine is to maintain the first light source in an activated state for a predetermined length of time following activation of the first light source and the second light source engine is to maintain the second light source in an activated state for a predetermined length of time following activation of the second light source.

14. The apparatus according to claim 13, further comprising:
a sensor engine to receive an indication from either or both of:
a first sensor to detect that media has been removed from the first output bin; and
a second sensor to detect that media has been removed from the second output bin; and
wherein the first light source engine and the second light source engine are to deactivate either or both of the first light source and the second light source prior to expiration of the predetermined length of time based upon the received indication or indications.

15. The apparatus according to claim 12, further comprising an output tray engine to control translation of an output tray, and wherein the second light source engine is to activate the second light source following translation of the output tray.
